(19) United States
(12) Patent Application Publication
(10) Pub. No.: US 2024/0336094 A1
(43) Pub. Date: Oct. 10, 2024

(54) PUNCTURE RESISTANT TIRES

(71) Applicant: The Goodyear Tire & Rubber Company, Akron, OH (US)

(72) Inventors: Cheng-Hsiung Lin, Hudson, OH (US); Bodo Ahrens, Trier (DE)

(21) Appl. No.: 18/602,401

(22) Filed: Mar. 12, 2024

Related U.S. Application Data
(60) Provisional application No. 63/495,191, filed on Apr. 10, 2023.

(51) Int. Cl. B60C 19/12

(52) U.S. Cl. CPC B60C 19/122

(57) ABSTRACT

A puncture resistant pneumatic tire may include a puncture resistant layer and a barrier layer. The puncture resistant layer may have a percent elongation of up to 300% and a tack value with the carcass of about 5 N to about 50 N at normal inflation pressure.

### FIELD OF THE INVENTION

The present disclosure relates generally to pneumatic tires, and more particularly to puncture resistant tires.

### BACKGROUND OF THE INVENTION

Prior art pneumatic tires are a multi-ply structure that depend on air in order to maintain their structural integrity. In order to retain the air, it is known to utilize one or more layers of plastic film to function as a puncture resistant structure. One problem with using a film is that it is restrained by the rubber due to the lamination, making it difficult to function as a puncture resistant layer. It is thus desired to have an improved pneumatic tire that overcomes the disadvantage of the prior art.

### SUMMARY OF THE INVENTION

A pneumatic tire in accordance with the present disclosure may comprise: a carcass; a barrier layer; and a puncture resistant layer, wherein the puncture resistant layer has a maximum percent elongation of up to 300% and a tack value with the carcass of about 5 N to about 50 N at normal inflation pressure. The puncture resistant layer may be located between the carcass and the air barrier layer, or radially inward of the air barrier layer.

In another aspect, a method in accordance with the present disclosure may comprise: positioning a barrier layer on a tire drum; adding layers to the barrier layer to produce a tire assembly, wherein the layers comprise a puncture resistant layer and a carcass, wherein the puncture resistant layer is between the carcass and the barrier layer, wherein the puncture resistant layer is laminated to the carcass, and wherein the puncture resistant layer has a tack value with the carcass of about 1 N to about 10 N; and shaping and curing the tire assembly to produce a vulcanized tire assembly.

### Definitions

“Axial” and “axially” mean lines or directions that are parallel to the axis of rotation of the tire.

“Circumferential” means lines or directions extending perpendicular to the axial direction.

“Inner” or “inwardly” means toward the inside of the tire.

“Normal inflation pressure” refers to the specific design inflation pressure and load assigned by the appropriate standards organization for the service condition for an individual tire.

“Outer” or “outwardly” means toward the outside of the tire.

“Pneumatic Tire” means a laminated mechanical device of generally toroidal shape (usually an open-torus) having beads and a tread and made of rubber, chemicals, fabric and steel or other materials. When mounted on the wheel of a motor vehicle, the tire through its tread provides traction and contains the fluid that sustains the vehicle load.

“Radial” and “radially” are used to mean directions radially toward or away from the axis of rotation of the tire.

“Tread” means a molded rubber component, which includes that portion of the tire that comes into contact with the road when the tire is normally inflated and under normal load. The tread has a depth conventionally measured from the tread outer surface to the bottom of the deepest groove of the tire.

“Tread block” or “Tread element” or “Traction element” means a rib or a block element defined by a shape having adjacent grooves.

### BRIEF DESCRIPTION OF THE DRAWINGS

The invention will be described by way of example and with reference to the accompanying drawings in which:

FIG. 1A is a cross-sectional view of a first example of a pneumatic tire.

FIG. 1B is a cross-sectional view of a second example of a pneumatic tire.

FIG. 2A is a close up view of the layers of the pneumatic tire shown in FIG. 1A.

FIG. 2B is a close up view of FIG. 2A after puncture by a sharp object 30, specifically illustrated as a nail.

FIG. 2C is an alternate embodiment of the tire of the present invention.

### DETAILED DESCRIPTION

The present disclosure relates generally to pneumatic tires that include a highly deformable, puncture resistant layer. The puncture resistant tires of the present disclosure may be used in multiple applications, for example, as race tires, passenger tires, aircraft tires, agricultural tires, earthmover tires, off-the-road tires, commercial (or truck) tires, and the like. At least in some instances, the puncture resistant layers of the present disclosure have several advantages including a high percent elongation, which allows the puncture resistant layers to be deformable yet retain their integrity and not puncture when contacted with a sharp object (e.g., a nail or a screw) that has penetrated an outer portion of the tire (e.g., the tread or the sidewall) and the carcass of the tire.

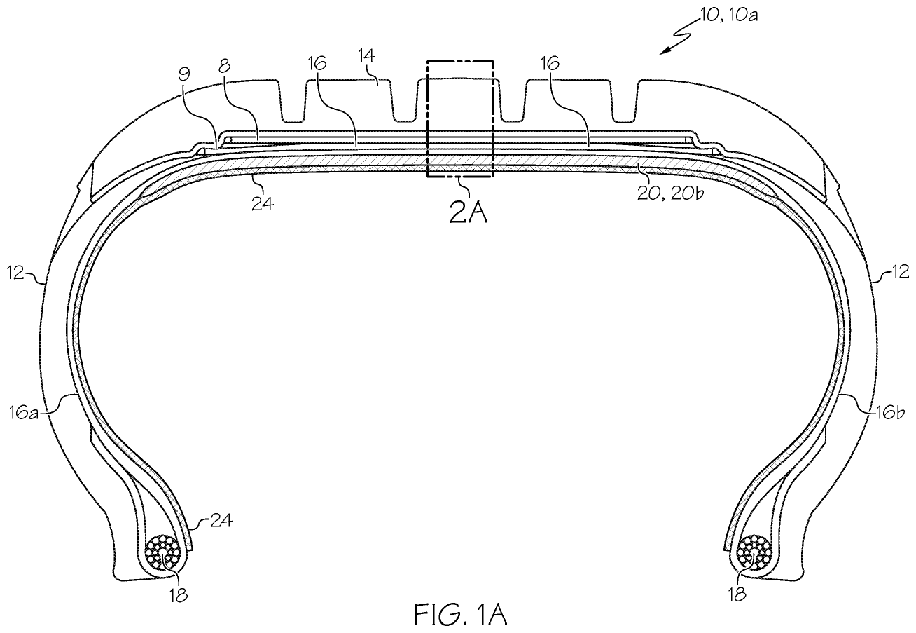

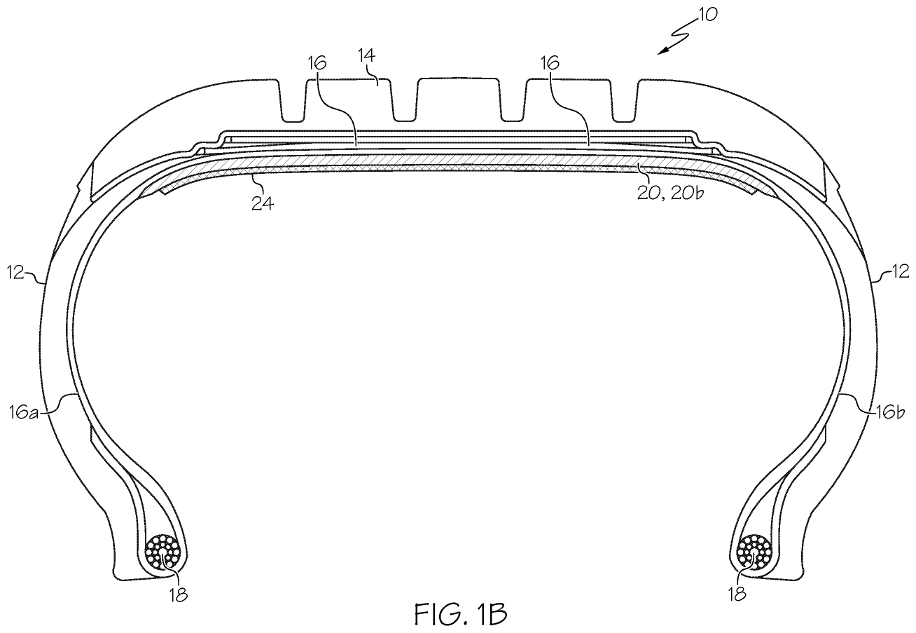

FIGS. 1A and 1B illustrate a first embodiment of a pneumatic tire 10 of the present disclosure that include opposed sidewalls 12 that extend radially inward from the axial outer edges of a tread 14, and wherein each sidewall is joined to a respective inextensible bead 18. The pneumatic tire further includes a first and second belt 8,9 and a carcass 16 composed of one or more layers of reinforced ply. The one or more layers of reinforced ply extend under the crown and from one bead 18 to the other bead and are secured thereto.

The pneumatic tire includes a puncture resistant layer 20 which is preferably located radially inward of the carcass 16. The puncture resistant layer 20 is a continuous layer that preferably extends underneath the tread only, although it may also extend under the tread and along the inner surface of the sidewalls.

The puncture resistant layer 20 is preferably highly deformable. The puncture resistant layer 20 may have a percent elongation of 300% or more (or in the range of about 50% to about 300%, or about 50% to about 150%, or about 100% to about 300% depending upon the desired result) (ASTM D412-16 (2021)). The elongation requirement may depend on other properties of the puncture resistant layer including, but not limited to, puncture resistance strength and delamination strength (tack between the carcass 16 and the puncture resistant layer 20). Generally, puncture resistant layer's puncture resistance strength should be higher than the delamination strength (tack between the carcass 16 and the puncture resistant layer 20). Preferably, the puncture resistant layer's puncture resistance strength (ASTM F1306-21) should be at least 2 times higher (or 2 times higher to 10 times higher, or 2 times higher to 5 times higher, or 3 times higher to 6 times higher, or 5 times higher to 10 times higher) than the delamination strength (tack between the carcass 16 and the puncture resistant layer 20).

The pneumatic tire may further include an air barrier layer 24. The puncture resistant layer 20 can serve as a shield that inhibits the sharp object 30 from otherwise penetrating the air barrier layer 24. At least because the puncture resistant layer 20 protects the structural integrity of the air barrier layer 24 from the intrusion of the sharp object 30, gas (e.g., air) can continue to be held within the penetrated tire 10c despite a hole in the tread portion 14 and the carcass 16 generated by the sharp object 30.

As the sharp object 30 is removed from the penetrated tire 10c, the force pushing on the puncture resistant layer 20, air barrier layer 24 away from the carcass 16 is reduced until it is ultimately removed. Accordingly, the inflation pressure of the penetrated tire can push the puncture resistant layer 20, and/or the air barrier layer 24 back towards the carcass 16 as the sharp object 30 is removed. Advantageously, after the sharp object 30 is removed, the normal inflation pressure may cause the puncture resistant layer 20 to self adhere (e.g., re-establish contact) to the carcass 16 and allow the puncture resistant layer 20 and barrier layer 24 to at least substantially return to their original configuration.

The puncture resistant layers described herein may comprise a rubber or thermoplastic material, preferably in the form of a thermoplastic film. The composition of the puncture resistant layer depends on the composition of the layer of the carcass to which the puncture resistant layer is laminated in the assembled tire and the normal inflation pressure of the tire. The composition of the puncture resistant layer may be selected to achieve the desired tack value (e.g., about 5 N to about 50 N at normal inflation pressure) with the carcass layer. A tack value between the carcass 16 and the puncture resistant layer 20 at normal inflation pressure may be about 50 Newtons (N) or less (or in the range of about 5 N to about 50 N) (ASTM D624-00 Type C configuration).

The amount of tack between the carcass 16 and the puncture resistant layer 20 may be controlled by the composition of each of said components, including the composition of the rubber and any additives in said rubber. The puncture resistant layer 20, in some instances, may be self adhered to the carcass 16 without an adhesive therebetween, which would increase the tack between the two components.

The puncture resistant layers of the present disclosure may have a thickness ranging, for example, from about 0.01 inches to about 0.1 inches (about 0.025 cm to about 0.25 cm) (or about 0.02 inches to about 0.08 inches (about 0.05 cm to about 0.2 cm)).

The tire may further include an air barrier layer 24. The air barrier layer 24 may be made of a butyl rubber compound, halo butyl compound or other conventional air barrier material known to those skilled in the art of tire building. The air barrier layer of the tire can define a thermoformable film of polymeric material, such as nylon or blend of nylon and rubber. Further examples include, but are not limited to: nylon 6, nylon 11, and/or nylon 12, which are manufactured from the corresponding lactams. Suitable nylon thermoformable films include, but are not limited to, DARTEK™ films available from DuPont of Wilmington, Delaware. In addition, the polymeric material of the thermoformable films may include, but are not limited to: polycondensates of aromatic dicarboxylic acids, e.g., isophthalic acid or terephthalic acid, with diamines, e.g., hexamethylenediamine, or octamethylenediamine, polycarbonates of aliphatic starting materials, e.g., m- and p-xylylenediamines, with adipic acid, suberic acid and sebacic acid, and polycondensates based on alicyclic starting materials, e.g., cyclohexanedicarboxylic acid, cyclohexanediacetic acid, 4,4′-diaminodicyclohexylmethane and 4,4′-diaminodicyclohexylpropane. The rubber used in the blend may include a natural and/or synthetic rubber. In one or more examples, the rubber includes butyl rubber, styrene butadiene rubber, and/or natural rubber.

The air barrier layer may also comprise butyl rubber or bromobutyl rubber with an inclusion of an ethylene vinyl copolymer (EVOH). The air barrier layer may also comprise a microlayer polymer composite film comprising alternating layers of polyurethane and an ethylene vinyl alcohol copolymer (EVOH). The alternating layers preferably have thicknesses ranging from about 0.01 microns to about 2.5 microns, and preferably there is from 10 to 1000 layers.

The air barrier layer 24 may be located radially inward of the puncture resistance layer so that the air barrier layer is the radially innermost layer, or located between the carcass and the puncture resistance layer.

The air barrier layer 24 is located radially inward of the tread, and may optionally extend between the inextensible beads 18. Alternatively, as illustrated in FIG. 1B, the innermost barrier layer 24b may have dimension along the inside of the pneumatic tire 10 that mirror that of the puncture resistant layer 20b.

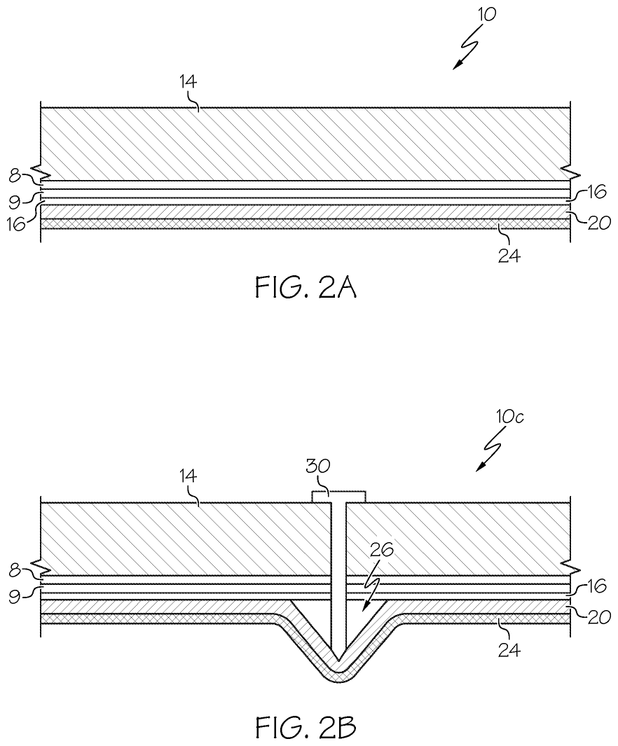

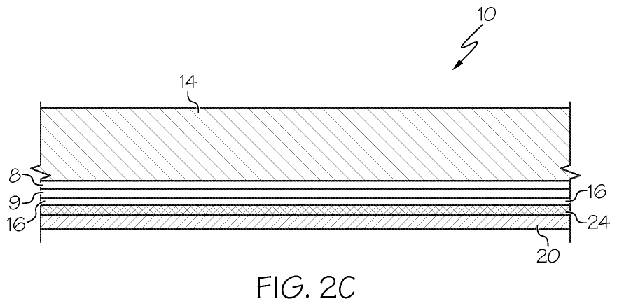

FIG. 2B shows the components of the pneumatic tire 10 of FIG. 2A where a sharp object 30, specifically illustrated as a nail, has penetrated the tread portion 14 and the carcass 16 to yield a punctured tire. A portion 26 of the puncture resistant layer 20 in proximity to the sharp object 30 has separated from the carcass 16 and deformed but not punctured, thereby protecting the barrier layer 24 from puncture. In contrast, puncture resistant layers in traditional tire compositions cannot deform as much, if at all.

The production of the tire including assembly of the components and curing thereof may be according to production methods conventionally known in the art. For example, assembly of a puncture resistant tire of the present disclosure can comprise applying the puncture resistant layer and the air barrier layer inside a green stage two tire carcass that has been shaped into a torus prior to vulcanization.

The production of the tire including assembly of the components and curing thereof may be according to production methods conventionally known in the art. For example, assembly of a puncture resistant tire of the present disclosure can comprise forming a green stage 2 tire carcass in the conventional manner, with or without the inner liner. A protective, removable liner is preferably used that is the radially innermost layer. After the tire is cured, the removable liner can be removed, and the puncture resistant layer and air barrier layer may be applied.

Further, as an additional advantage, once the sharp object is removed from the pneumatic tire, the puncture resistant layer may return to its original shape (or close to its original shape) and re-engage the carcass at the puncture site, bringing the puncture resistant layer and the underlying layers at least substantially back to their original configuration. This may allow for continued use of the pneumatic tire with minimal effect on the tire lifetime.

Variations in the present disclosure are possible in light of the description herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire comprising:
a carcass;
an air barrier layer; and
a puncture resistant layer located adjacent the carcass, and having a post cure tack value with the carcass of less than about 50 N at normal inflation pressure.

2. The pneumatic tire of claim 1, wherein the puncture resistant layer is adhered to the barrier layer.

3. The pneumatic tire of claim 1, wherein the puncture resistant layer has a thickness of from about 0.025 cm to about 0.25 cm.

4. The pneumatic tire of claim 1, wherein the puncture resistant layer is adhered to the carcass without an adhesive therebetween.

5. The pneumatic tire of claim 1 wherein the puncture resistant layer has an elongation at break of at least 300%.

6. The pneumatic tire of claim 1 wherein the puncture resistant layer has a maximum percent elongation of up to 300%.

7. The pneumatic tire of claim 1 wherein the puncture resistant layer extends underneath the tread.

8. The pneumatic tire of claim 1 wherein the puncture resistant layer extends along a portion of the carcass and does not wrap around the inextensible beads.

9. The pneumatic tire of claim 1, wherein the air barrier layer is a microlayer polymer composite film comprising alternating layers of polyurethane and an ethylene vinyl alcohol copolymer (EVOH).

10. The pneumatic tire of claim 1, wherein the air barrier layer is a butyl rubber or bromobutyl rubber with an inclusion of an ethylene vinyl copolymer (EVOH).

11. A pneumatic tire comprising:
a carcass;
an air barrier layer; and
a puncture resistant layer located adjacent the air barrier layer, and having a post cure tack value with the air barrier layer of less than about 50 N at normal inflation pressure.

12. The pneumatic tire of claim 11, wherein the puncture resistant layer is adhered to the barrier layer.

13. The pneumatic tire of claim 11, wherein the puncture resistant layer has a thickness of from about 0.025 cm to about 0.25 cm.

14. The pneumatic tire of claim 11, wherein the puncture resistant layer is adhered to the air barrier layer without an adhesive therebetween.

15. The pneumatic tire of claim 11 wherein the puncture resistant layer has an elongation at break of at least 300%.

16. The pneumatic tire of claim 11 wherein the puncture resistant layer has a percent elongation of up to 300%.

17. The pneumatic tire of claim 11 wherein the puncture resistant layer extends underneath the tread.

18. The pneumatic tire of claim 11 wherein the puncture resistant layer extends along a portion of the carcass and does not wrap around the inextensible beads.

19. The pneumatic tire of claim 11, wherein the air barrier layer is a microlayer polymer composite film comprising alternating layers of polyurethane and an ethylene vinyl alcohol copolymer (EVOH).

20. The pneumatic tire of claim 11, wherein the air barrier layer is a butyl rubber or bromobutyl rubber with an inclusion of an ethylene vinyl copolymer (EVOH).
